(19) United States
(12) Patent Application Publication
(10) Pub. No.: US 2026/0139115 A1
(43) Pub. Date: May 21, 2026

(54) METHOD FOR RECYCLING MIXED-COLOUR POLYOLEFIN CONTAINERS

(71) Applicant: ALPLA WERKE ALWIN LEHNER GMBH & CO. KG, Hard (AT)

(72) Inventor: Michael HEYDE, Bergisch Gladbach (DE)

(21) Appl. No.: 19/481,959

(22) PCT Filed: May 17, 2024
(86) PCT No.: PCT/EP2024/063688

§ 371 Date: Nov. 6, 2025

(30) Foreign Application Priority Data
May 22, 2023 (CH) CH000543/2023

(51) Int. Cl. C08J 11/06; B29B 17/02; B29B 17/04; B29K 23/00; B29K 105/26

(52) U.S. Cl. CPC C08J 11/06; B29B 17/02; B29B 17/0412; B29B 2017/0203; B29K 2023/00; B29K 2105/26; C08J 2323/00

(57) ABSTRACT

A method for recycling color-mixed polyolefin containers to produce PCR (Post Consumer Recycled) granules includes the following steps: color sorting the containers, comminuting the containers into flakes, first washing step to remove labels from the flakes by using water at a temperature T1, drying the flakes and labels, separating the dried flakes from the dried labels, second washing step to hot wash the flakes by using an alkaline liquid at a temperature T2>80° C. to remove printing ink from the flakes, drying the flakes, sorting the flakes to remove color contamination and foreign polymers, degassing and granulating the flakes in an extruder, decontaminating the granules and making the granules available for further use. The first washing step is carried out without cleaning additives at a temperature T1 between 60° C. and 80° C. while thermal energy is supplied.

### FIELD OF THE INVENTION

The invention relates to a method for recycling color-mixed polyolefin containers to produce PCR (Post Consumer Recycled) granules according to the preamble of claim 1.

### PRIOR ART

A processing method for producing polyolefin recyclates is known from the prior art, in which method color-mixed polyolefin-containing residues are comminuted into flakes. The flakes are subjected to a first wash at a low temperature, a second wash at an increased temperature in an alkaline medium, sorting, and granulation and degassing in an extruder. The resulting granular material can be used to produce new consumer product packaging.

The first wash is carried out by using water without the addition of thermal energy to prevent the printing inks from ‘bleeding’ from the label residues on the flakes. However, the label residue is not adequately removed in the first wash.

### OBJECT OF THE INVENTION

The disadvantages of the described prior art give rise to the object of establishing an improved processing method in which the label residues are reliably removed from the flakes.

### DESCRIPTION

The solution to the stated object is found in a method for recycling color-mixed polyolefin containers to produce PCR (Post Consumer Recycled) granulate by the features indicated in the characterizing portion of claim 1. The dependent claims relate to developments and/or advantageous alternative embodiments.

The invention is preferably characterized in that the first washing step (c) is carried out without cleaning additives at a temperature T₁ between 60° C. and 80° C. while thermal energy is supplied. According to the prior art, the washing step (c) is performed as a cold wash without thermal energy being supplied. The washing water therefore has a temperature T₁ of largely less than 40° C. The temperature Ti is slightly above the ambient temperature due to the considerable mechanical energy input from comminutors and washing units. At this temperature, it is ensured that the printing inks of the labels are not dissolved in the washing water (‘bleeding’) and therefore the flakes are not contaminated with the printing ink. Therefore, at washing water temperatures of 60° C.<T₁<80° C., bleeding of the label printing ink would have been expected. Surprisingly, the printing ink on the labels does not wash out in this temperature range. In this temperature range, the labels and their adhesive residues can be almost completely removed from the flakes, resulting in a significant improvement in quality compared to the recyclates available on the market, which flakes can be used to produce new consumer product packaging.

In a preferred embodiment of the invention, by connecting a plurality of color sorters in series, the color purity in the color sorting of step (a) is greater than 90% by weight and preferably greater than 93% by weight. Preferably, white and transparent containers are separated from colored containers in a first step. Thus different color fractions of a high color purity can be obtained and the relevant main color of the individual color fraction is only slightly affected by incorrect color sorting.

Advantageously, the color-sorted containers according to step (a) are pressed into bales in a pressing step (a1) and the bales are transported to the location of further processing according to steps (b) to (l) in a transport step (a2). Compressing into bales enables efficient intermediate storage of the sorted bottles and potentially saves transport costs.

Further advantages and features will become apparent from the following description of an embodiment of the invention with reference to a schematic flow chart representation.

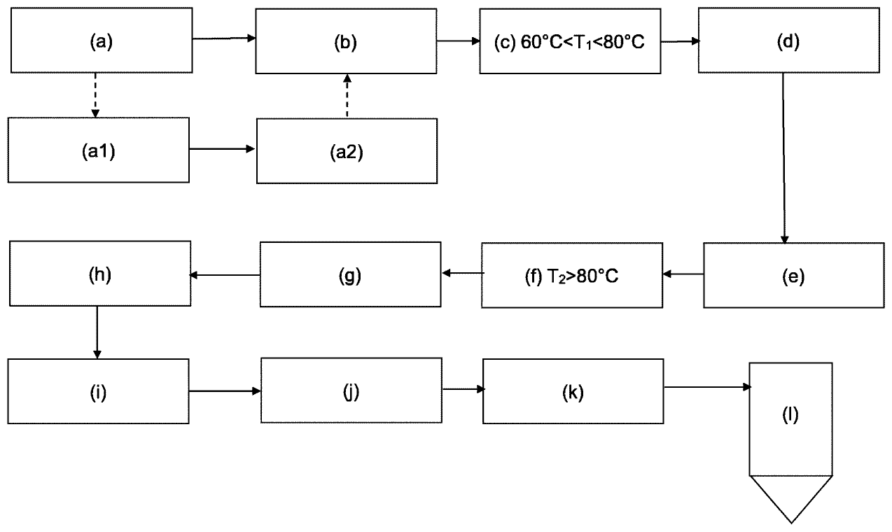

FIG. 1 is a flow chart of a method according to the invention for recycling color-mixed polyolefin containers. The flow chart of the method for recycling color-mixed polyolefin containers to produce PCR (Post Consumer Recycled) granules shows the method steps (a) to (l) in a predetermined sequence. In a first method step (a), the discarded and collected polyolefin containers, which are still unwashed, are color sorted. Color sorting is carried out so as to have a color purity of over 90%, preferably more than 93% by weight. This means that at least 93% by weight of the color-sorted containers are of a specific color. This high degree of color separation is achieved by connecting a plurality of color sorters in series. This allows a plurality of color-pure polyolefin fractions to be obtained.

To increase the overall availability of the plant technology, it is advisable to decouple pre-sorting and washing methods by means of an intermediate storage facility. For efficient storage and if the further method steps (b) to (l) take place at a different location, it is advisable to press the polyolefin containers into bales (step (a1)) and transport the bales to the location of further processing (step (a2)). This means that the transport and storage volume of recycled goods can be significantly reduced.

The containers are comminuted into flakes in step (b). Comminuting can be performed, for example, in a cutting mill or a shredder. Comminuting can be carried out both wet (i.e. with the addition of water or moisture) and dry. Wet grinding effectively prevents dust formation and limits costly wear on the cutting tools.

Typically, the first washing step (c) is carried out by using washing water without heating the washing water. Therefore, according to the prior art, the temperature T₁ of the washing water is always colder than 60° C. and is often 40° C. or less. In the first washing step, any labels still stuck to the flakes, as well as food residues or salt, are removed. The cold wash ensures that the labels do not ‘bleed’, i.e., that printing ink does not dissolve from the labels and contaminate the color-sorted flakes. In contrast, in the method according to the invention, the first washing step (c) is carried out by using washing water which is heated to a temperature of <80° C., preferably to a temperature between 60° C. and 80° C. by heating (external heat supply, e.g. via a heat exchanger).

In fact, it should be assumed that the label ink bleeds at a temperature T₁ above 60° C. Surprisingly, however, it has been shown that the first washing step without cleaning additives at a temperature between 60° C. and 80° C. while thermal energy is supplied does not lead to the label ink washing out. However, detaching the labels is significantly improved in this temperature range.

After drying the flakes and labels together (step (d)), the flakes are separated from the labels in step (e).

In a second washing step (f), the flakes are washed in a hot wash by using an alkaline liquid at a temperature T₂ exceeding 80° C. The washing liquid is heated by thermal energy being supplied. At this high temperature in the additionally alkaline environment, the few label residues that remain adhered and printing inks from direct printing are removed from the flakes.

After the second washing step (f), the flakes are dried in step (g) and can be made available for further processing, for example in a first bunker.

In step (h), the flakes are sorted to remove color contamination and foreign polymers, which significantly improves the purity of the recyclate.

In an optional preheating step (i) of the flakes, they are fed into a cutter-compactor. According to method step (j), the flakes are melted in an extruder and the molten mass is degassed, filtered and granulated. The material is degassed by applying a vacuum, whereby the polyolefin molten mass is rid of volatile components and the odor pollution caused by the granules is significantly reduced.

In step (k), the granules are decontaminated by exposing them to a temperature in the range of 50 to 155° C., preferably for a period of at least 60 min. This treatment ensures that any pollutants, migration products or contaminants still contained in the granulate that have diffused into the outermost layer of the receptacle are separated as far as possible. This removes any odorous substances still present in the granules.

Finally, the high-quality granulate is made available for further use, for example in a bunker, or it is packed into big packs (step (l)).

### LIST OF REFERENCE SIGNS:

a color sorting the containers
a1 pressing the containers
a2 transporting the bales
b comminuting the containers
c first washing step of the flakes
d drying the flakes
e separating the flakes from the labels
f second washing step of the flakes
g drying the flakes
h sorting the flakes
I preheating the flakes
j degassing and granulating the flakes
k decontaminating the granules
l making the granules available

1-3. (canceled)

4. A method for recycling color-mixed polyolefin containers to produce PCR (Post Consumer Recycled) granules, comprising the steps of:
(a) color sorting the containers,
(b) comminuting the containers into flakes,
(c) a first washing step to remove labels from the flakes by using water at a temperature T1,
(d) drying the flakes and labels,
(e) separating the dried flakes from the dried labels,
(f) a second washing step to hot wash the flakes by using an alkaline liquid at a temperature T2>80° C. to remove printing ink from the flakes,
(g) drying the flakes,
(h) sorting the flakes to remove color contamination and foreign polymers,
(i) optionally preheating of the flakes in a cutter-compactor,
(j) degassing and granulating the flakes in an extruder,
(k) decontaminating the granules and
(l) making the granules available for further use, wherein the first washing step (c) is carried out without cleaning additives at a temperature T1 between 60° C. and 80° C. while thermal energy is supplied.

5. The method according to claim 4, further comprising connecting a plurality of color sorters in series, wherein the color purity in the color sorting of step (a) is greater than 90% by weight, and preferably greater than 93% by weight.

6. The method according to claim 4, wherein the color-sorted containers according to step (a) are pressed into bales in a pressing step (a1) and the bales are transported to the location of further processing according to steps (b) to (l) in a transport step (a2).
